(19) United States
(12) Patent Application Publication
(10) Pub. No.: US 2026/0357870 A1
(43) Pub. Date: Nov. 12, 2026

(54) PLATE FOR JOINING TWO END PORTIONS OF A CONVEYOR BELT, JOINING DEVICE COMPRISING AT LEAST ONE SUCH JOINING PLATE, AND ASSOCIATED STRIP OF JOINING PLATES

(71) Applicant: FP BUSINESS INVEST, Saint-Chamond (FR)

(72) Inventors: Bernard TAVERNIER, Le Chambon Feugerolles (FR); Marie DUBUY, Le Chambon Feugerolles (FR); Frédéric GUILLEMET, Francheville (FR)

(73) Assignee: FP BUSINESS INVEST, Saint-Chamond (FR)

(21) Appl. No.: 18/997,078

(22) PCT Filed: Jul. 28, 2023
(86) PCT No.: PCT/EP2023/071099

§ 371 Date: Jan. 18, 2025

(30) Foreign Application Priority Data
Jul. 29, 2022 (FR) FR2207941

(51) Int. Cl. F16G 3/08

(52) U.S. Cl. CPC F16G 3/08

(57) ABSTRACT

The invention relates to a joining plate (4) for a joining device (1) for a conveyor belt (2) intended to connect two end portions (21, 22) of at least one conveyor belt (2), the joining plate (4) having an outer surface (S1) intended to be flush with a useful surface of the conveyor belt (2) in the joining position and an inner surface (S2) opposite the outer surface (S1) and intended to at least partially cover the two end portions (21, 22) of the conveyor belt (2) in the joining position, the joining plate comprising: a body (45) made of flexible material, having an outer surface forming the outer surface (S1) of the joining plate (4); a reinforcement plate (11) having fastening through-holes, rigidly connected to the body; and a plurality of inserts (6) at least partly embedded in the body (45) and each having a fastening opening associated with one of the fastening holes, so as to surround a rim of the associated fastening hole on one side of the reinforcement plate (11), for accommodating fastening means (5) of the joining device (1) with the end portions (21, 22), the joining plate (4) being characterized in that the body (45) at least partly covers the fastening openings of the inserts.

### TECHNICAL FIELD OF THE INVENTION

The invention generally relates to the technical field of joining devices for conveyor belts intended to connect the ends of a conveyor belt. For the sake of simplification, the term conveyor belt used in the present description by convention will equally mean a conveyor belt and a belt.

More specifically, the invention relates to a joining plate for connecting two end portions of a conveyor belt, particularly provided with a textile reinforcement, to a joining device for a conveyor belt comprising at least one such joining plate, and to an associated strip of joining plates.

### PRIOR ART

Conveyor belts are known that are used for transporting, or conveying, various materials or various products, such as coal, ores, industrial or agricultural products. These conveyor belts are made up of belts made of a reinforced elastomer, or of a reinforced synthetic material, with a suitable length and width, the ends of which must be connected together, before assembly, or after assembly, on support and drive devices comprising return rollers and idler rollers. Often, these devices also comprise tensioning components, the purpose of which is to properly tension the conveyor belt.

Until now, various means have been used to connect the ends of conveyor belts.

Originally, and even today, vulcanization is used when the belt is made of a reinforced vulcanizable elastomer. Following preparation work that is intended to create matching profiles in each end that press together when said ends are brought closer together, the vulcanization is carried out by adding heat and pressure, as is well known. An alternative of vulcanization is cold bonding.

Another known connection means involves using staples in the general shape of a U, and cut from a metal strip, which staples comprise upper plates and lower plates connected by knuckles, with these staples being fastened in two series straddling over each end of the conveyor belt to be connected, such that the knuckles protrude and such that the knuckles of one series can be interleaved between the knuckles of the other series, with a connection and articulation rod then being passed inside the interleaved knuckles so as to thus connect the two ends by forming a type of hinge. The known means used to fasten the staples on the ends of the conveyor belt are made up of rod fastening means such as studs, rivets and screws.

In the more recent past, joining devices have been proposed that use flat connecting elements, generally made of reinforced elastomer or of reinforced synthetic material, respectively disposed on either side of the ends of the conveyor belt and fastened on said ends to be connected. Examples of such joining devices are provided in patents EP-0827575-B1 and EP-1163459-B1. These devices comprise an upper joining plate and a lower joining plate, optionally connected by a central portion. These lower and upper joining plates have a spacing that is designed to engage the respective end of a conveyor belt therein, by causing it to approximately come into abutment against the central portion, or even, in the event that the joining device does not have a central portion, against a spacer provided for this purpose during assembly, then subsequently removed. In other words, these joining devices comprise two pairs of fastening wings facing each other, with the ends of the conveyor belt being respectively introduced between two wings of the same pair. Fastening the lower and upper parts forming a joining plate on the ends of the conveyor belt is generally carried out by means of rivets, spikes, studs, screw-nut systems, or even by cold bonding or by flat vulcanization of the wings against the flat outer surfaces of the conveyor belt engaged between the wings.

The joining devices are generally made of a flexible and resilient material, for example, of vulcanized rubber, or of a synthetic material, such as polyurethane, in which a reinforcement, generally a textile reinforcement, is embedded, having extensibility in the longitudinal reference direction of the conveyor belt.

The extensibility of the reinforcements for this type of joining device, in the longitudinal direction of the conveyor belt, is intended to allow the joining devices mounted on the conveyor belts to repeatedly cross, without any excessive wear or fatigue that could lead to rapid deterioration, the curved parts of the path of the conveyor belts, namely, the curvature of the drive rollers, the return rollers and the tensioning rollers. Indeed, during this operation, the upper part of the joining devices experiences a tensile force, while their lower part (i.e., the part oriented toward the outer surface of the rollers) experiences a compressive force, and this is due to the difference in the path of these parts, with these paths being directly proportional to the radius of curvature, which varies due to the thickness of the joining devices.

Since the stresses are quite different between the lower and upper parts, and in order to further improve the wear resistance of these joining devices, the Applicant has improved their product in the past so as to provide the upper part with greater extensibility than that of the lower part. In this type of conveyor belt junction, the central portion has then evolved so as to be detached from the lower and upper plates, in order to leave room for the use of independent spacers, which are used during assembly and against which the first one of the ends of the conveyor belt that is placed in the junction comes into abutment, between the lower and upper plates, then these spacers are removed before the second one of the ends of the conveyor belt is installed. Indeed, the joining devices were produced by molding or by injection and had an H-shaped structure, the lower and upper plates and the central portion of which were formed as a single piece. In order to manufacture them this would require as many molds as the thicknesses of the conveyor belts encountered in the field, and these joining devices consequently had to be manufactured in very small production runs, which increased the cost price for manufacturing, storage and distribution.

This problem, namely that of the plethora of molds and molded products required for the various thicknesses of conveyor belts, has been solved, notably by producing, as explained above, the joining devices in three separate parts: a part forming upper left and right wings forming a single piece, a part forming lower left and right wings forming a single piece, and an intermediate part, corresponding to the middle bar of the H-shaped profile, with this intermediate part forming a spacer. In such a configuration it is then possible to manufacture the two lower and upper plates in isolation, and each is configured so as to be adapted to the forces that they experience (compressive/tensile forces) and to the associated stresses. For example, the lower plate is arranged to pass over drive rollers, return rollers and tensioning rollers without experiencing any damage, with said rollers driving or returning the conveyor belt to the ends where the considered joining device is mounted, with the lower plate coming into direct contact with these components for driving the belt. For its part, the upper plate is in direct contact with the various materials or the various products conveyed on the conveyor belt. Furthermore, the upper plate is also generally swept by wipers.

In any case, extensibility has become a predominant feature in the design of such a joining plate with a view to obtaining a sufficiently flexible and resilient joining device that is able to pass over drive rollers and return rollers without experiencing any damage, while being provided with tensile strength that allows it to withstand all the forces that it experiences without being damaged. These features of extensibility and of resistance to such forces for the joining plate are conferred both by the flexible and resilient material (vulcanized rubber, synthetic material such as polyurethane) forming the joining plate and by the reinforcement that is integrated therein, offering both extensibility in the longitudinal direction of the conveyor belt and resistance that is adapted to withstand the greater tensile forces experienced by the conveyor belt.

Despite the progress that has been made concerning the extensibility of such a joining plate, the Applicant is constantly developing their product in order to increase the flexibility and to improve the dynamic behavior of a joining device. It has been found that the fastening means (such as screws or rivets) securing the joining plates significantly affect the stiffness of the joining plates, and more generally of the joining device. This constraint is even more significant in some applications, such as for conveyor belts called high-endurance coating conveyor belts. Indeed, in order to improve abrasion resistance and to increase the service life of the conveyor belt, a known configuration of a conveyor belt involves the layer of flexible and resilient material covering over the reinforcement, for example a textile reinforcement, being thicker than the layer of flexible and resilient material located under said reinforcement. In other words, the reinforcement is not located at the center of the thickness of the belt but is offset toward the face of the conveyor belt that comes into direct contact with the components for driving the conveyor belt. For this type of application, the means for fastening the joining plates of a given joining device each pass through one of the joining plates, one of the end portions of the conveyor belt, then the other one of the joining plates. The length of the fastening elements is limited by the thickness of the joining plates together with the end portion, notably to ensure that the fastening means are correctly housed in the inserts that are at least partly incorporated into the upper and lower plates. The result of such a limitation is the presence of as many fastening interfaces as there are fastening elements on the outer surfaces of the associated joining plate, with interfaces representing zones that become conducive to the appearance of defects in the material of the joining plate, for example cracks. Furthermore, the mobility of the fastening means during the passages of the return components of the conveyor belt involves an increased mechanical stress on the material of the upper joining plate, which is also a source of premature wear.

### DISCLOSURE OF THE INVENTION

The invention aims to overcome all or some of the disadvantages of the prior art by notably proposing a solution for improving the flexibility of the joining devices, while further improving their structural strength in order to improve their operating duration, and thus further limit any maintenance operations.

To this end, according to a first aspect of the invention, a joining plate is proposed for a joining device for a conveyor belt intended to connect two end portions of at least one conveyor belt, the joining plate having an outer surface intended to be flush, i.e., level, with a useful surface of the conveyor belt in the joining position and an inner surface opposite the outer surface and intended to at least partially cover the two end portions of the conveyor belt in the joining position, the joining plate comprising:
a body made of flexible material, having an outer surface forming the outer surface of the joining plate;
a reinforcement plate having fastening through-holes, rigidly connected to the body; and
a plurality of inserts at least partly embedded in the body and each having a fastening opening associated with one of the fastening holes, so as to surround a rim of the associated fastening hole on one side of the reinforcement plate, for accommodating fastening means of the joining device with the end portions;
   the joining plate being noteworthy in that the body at least partly covers the fastening openings of the inserts.

By virtue of such a combination of features, the joining plate is thus devoid of inserts and/or fastening elements in an upper part that is only formed by the body of the joining plate, which provides it with increased flexibility and better dynamic behavior, in particular for the passage of the drive components and the return components, such as the rollers of a conveyor carriage or of a conveyor. In this way, irrespective of the total thickness of the joining plate adapted to a determined joining operation, it is possible to limit the impact of the fastening elements on the flexibility of the junction. With the length of the fastening elements of a joining device comprising such a joining plate thus being independent of the thickness of the joining plate, the stiffness of the joining plate can be limited.

According to one embodiment, the body has a minimum thickness, measured between the outer surface and the inserts, that is greater than or equal to a distance equal to a height of the associated inserts. Preferably, this minimum thickness is at least a few millimeters.

According to one embodiment, the joining plate has an outer surface formed by an outer surface of the body and an inner surface opposite the outer surface and formed by an inner surface of the body and/or of the reinforcement plate, the outer surface and the inner surface being equidistant from each other on either side of a middle plane of the joining plate, the reinforcement and the inserts being positioned on the inner side of the joining plate relative to the middle plane, for example between the middle plane and the inner surface.

The middle plane of the joining plate delimits an upper half of the joining plate located on the side of the outer surface of said joining plate relative to the middle plane of a lower half of the joining plate located on the side of the inner surface of said joining plate relative to the middle plane, with the distance separating the outer surface and the inner surface of the body delimiting a thickness of the joining plate.

According to one embodiment, the reinforcement plate and the inserts are housed on the side of the lower half of the joining plate relative to the middle plane, at least partly, or even fully, in the lower half of the joining plate relative to the thickness thereof, on the side of the inner surface.

The thickness of the joining plate is therefore delimited by the distance between the outer and inner surfaces of said plate. The lower half of the thickness in this case designates the “lower half” of the associated joining plate, and in particular of the body of the joining plate. By contrast, the upper half of the joining plate, and in particular of the body of the joining plate, is located above the lower half.

By virtue of such a combination of features, the joining plate is thus devoid of inserts and/or fastening elements in its upper half, further improving its extensibility in this zone that experiences the most stress during the passage of the drive components and of the return components.

According to one embodiment, the reinforcement plate is housed in the body and extends at a constant distance from the outer surface. The reinforcement plate can be integrally housed in the body so that the inner surface of the joining plate is simply formed by an inner surface of the body itself. Alternatively, the reinforcement plate can be positioned flush with the inner surface of the joining plate, which is then formed by an inner surface of the joining plate, or even also of the body.

According to one embodiment, the reinforcement plate is textile, i.e., it comprises, preferably is formed by, at least one layer, or even a plurality of layers, of textile. The reinforcement plate, or reinforcement, thus forms a woven reinforcement improving the resistance of the joining plate to the tensile forces.

According to one embodiment, the body is formed from an elastomer material, preferably made of rubber, and has extensibility ranging between 15% and 40%, preferably between 20% and 30%.

According to one embodiment, the body of the joining plate has holes extending from the inner surface of the body in the lower half of the joining plate, the holes being configured to partly house the fastening means. These holes in line with each of the inserts each at least emerge on the side of the inner surface of the joining plate, but they can remain located in the lower half of the plate. In this configuration, an upper part of the joining plate supporting the outer surface, preferably the upper half thereof, can be devoid of holes. This reduces the number of zones conducive to the appearance of defects, for example cracks. The dynamic behavior of the joining plate and of the whole device is thus improved.

According to one embodiment, the body of the joining plate comprises through-holes, extending from the outer surface of the body of the joining plate toward the inner surface of the joining plate, the holes being configured to be each traversed by one of the fastening means. Preferably, the through-holes are cylindrical. Such through-holes are located in line with each of the inserts and thus each provide a lane function for routing the fastening means toward the associated insert.

According to one embodiment, a diameter of each through-hole is configured so as to be strictly less than a diameter of the fastening openings of the associated insert so that the body partly covers said fastening openings of the inserts. By virtue of the resilience of the material forming the body of the joining plate, it would appear that each hole is configured to resiliently deform when one of the fastening elements passes through or is introduced into said hole, with the associated hole being delimited by the body of the joining plate and then returning to its initial shape once the fastening element has been removed, when the plate and the device are assembled in the joining position and each fastening element cooperates with the associated insert. In practice, and unlike received opinion, resistance tests have shown that the fastening elements do not cause premature wear due to any friction with the body of the joining plate.

According to one embodiment, each of the through-holes is coaxial with one of the fastening openings of one of the associated inserts of the joining plate. Preferably, cach through-hole is also coaxial with the associated fastening hole of the reinforcement plate.

According to another aspect of the invention, the invention relates to a joining device for a conveyor belt intended to connect two end portions of at least one conveyor belt, the joining device being noteworthy in that it comprises at least one joining plate as described above.

According to one embodiment, the joining device for a conveyor belt comprises a first joining plate according to any of the aforementioned embodiments and a second plate comprising a plurality of inserts, the two plates being configured to each cover a separate side of the ends of the conveyor belt so that said conveyor belt is disposed between the two joining plates in the joining position, the first and second joining plates being fastened together by fastening means arranged to at least partly respectively penetrate a joining plate from among the first and the second joining plate, one of the ends of the conveyor belt and then the other joining plate from among the first and the second joining plate.

According to one embodiment, a thickness of the first joining plate is greater than or equal to, preferably strictly greater than, a thickness of the second joining plate of the joining device, preferably greater than or equal to twice the thickness of the second joining plate, more preferably greater than or equal to three times the thickness of the second joining plate. According to the technical language of the technical field, such a configuration is referred to as a “high-endurance coating” plate. In such a configuration, the high-endurance coating is supported on the upper joining plate of the joining device.

According to one embodiment, the fastening means comprise rod fastening means, preferably of the screw type, the fastening means each preferably comprising a head configured to cooperate with a portion of the inserts and an anchoring section, preferably provided with a thread, configured to cooperate with another portion of the inserts. In alternative and/or additional configurations, the fastening means can comprise rivets.

According to one embodiment, the inserts configured to each cooperate with a head of the fastening means each comprise a washer perforated by the associated fastening opening surrounded by a cup able to house the head of the fastening means.

According to one embodiment, the inserts configured to each cooperate with an anchoring section of the fastening means each comprise a cylindrical tubular portion delimiting the associated fastening opening for which an inner cylindrical surface is able to cooperate with an anchoring section of the fastening means, the inner cylindrical surface preferably comprising a tapping.

According to one embodiment, the first plate only comprises the tapped inserts configured to cooperate with the threaded anchoring sections of the fastening means. Alternatively, the first joining plate only comprises inserts configured to cooperate with the heads of the fastening means.

According to one embodiment, the through-holes are each coaxial with the fastening openings of each associated pair of inserts of the first plate and of the second plate, in the joining position, when the first and second joining plates are in a joining position. Such a configuration allows vertical alignment of the inserts of each pair of inserts associated with a given fastening means in order to allow it to be anchored.

According to one embodiment, a diameter of the through-holes is strictly smaller than a diameter of the fastening opening of the associated insert, preferably strictly less than an outer diameter of the head of the associated fastening element, preferably strictly less than a nominal diameter of the anchoring section of the associated fastening element, more preferably substantially equal to the thread root diameter of the thread of the anchoring section of the associated fastening element.

According to another aspect of the invention, the invention relates to a method for manufacturing a joining plate according to any of the embodiments described above, characterized in that it comprises at least the following steps of:
manufacturing a continuous series of a plurality of joining plates in strip form; and
cutting, from said strip thus manufactured, joining plates according to predetermined dimensions.

Such a manufacturing method is particularly advantageous in that it allows continuous manufacturing of several successive joining plates. Each of the first and second joining plates, intended to form the lower and upper joining plates of the joining device, is then cut into an associated strip or strip portion thus manufactured and specifically adapted to the desired use.

According to another aspect, the invention also relates to a method for joining a first end portion and a second end portion of a conveyor belt using a joining device for a conveyor belt as described above, comprising a first joining plate according to the invention and a second joining plate, characterized in that it comprises at least:
a step involving the first joining plate and the second joining plate each covering a separate side of the end portions of the conveyor belt so that said conveyor belt is vertically interposed between the two joining plates, said first and second joining plates forming a first pair of wings that is adapted to clamp the first end portion of the conveyor belt and a second pair of wings that is adapted to clamp the second end portion of the conveyor belt;
a step of inserting the second end of the conveyor belt between two wings of the second pair of wings;
a step of fastening the second end portion of the conveyor belt with the two wings of the second pair of wings between which it is positioned;
a step of inserting the first end of the conveyor belt between the two wings of the first pair of wings,
a step of fastening the first end of the conveyor belt with the two wings of the first pair of wings between which it is positioned.

### BRIEF DESCRIPTION OF THE DRAWINGS

Further features and advantages of the invention will become apparent upon reading the following description, with reference to the appended figures, which illustrate:

FIG. 1: a plan view of a joining device for a conveyor belt of the prior art, as a top view,

FIG. 2: a longitudinal section view, along section A-A of FIG. 1, of a joining device, showing an exploded view of its various constituent elements;

FIG. 3a: a longitudinal section view of a joining device for a conveyor belt according to a first embodiment, showing an exploded view of its various constituent elements;

FIG. 3b: a longitudinal section view of a joining device according to the same embodiment, in an intermediate assembly position;

FIG. 3c: a longitudinal section view of a joining device according to the same embodiment, in a joining position;

FIG. 4a: a longitudinal section view of a joining device for a conveyor belt according to another embodiment of the invention, showing an exploded view of its various constituent elements;

FIG. 4b: a longitudinal section view of a joining device according to the same embodiment of the invention.

For greater clarity, identical or similar elements are identified using identical reference signs throughout all the figures.

In the description and the claims, in order to clarify the description and the claims, the longitudinal, transverse and vertical terminology will be adopted in a non-limiting manner with reference to the X, Y, Z trihedron shown in the figures.

Furthermore, the terms “upper”, “lower” and their derivatives refer to the position or to the orientation of an element or of a component, with this position or this orientation being considered when the joining plates are in the service configuration and extend in a horizontal plane.

### DETAILED DESCRIPTION OF EMBODIMENTS

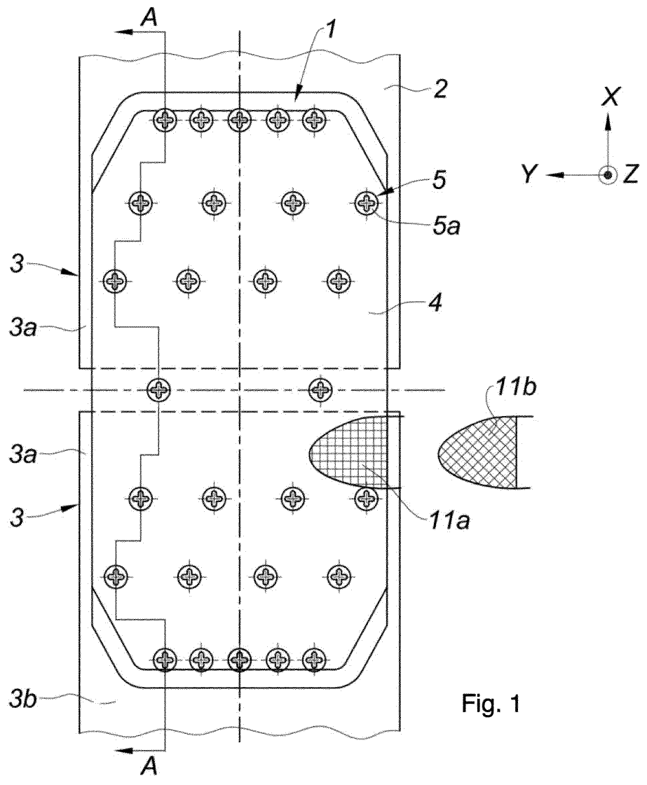

FIG. 1 is a plan view, from above, of a joining device 1 according to the prior art and shows an upper joining plate 4 of a joining device 1. The heads 5a of the screws 5 that form an example of means for assembling the joining devices also can be seen.

The cutouts 11a and 11b show two types of textile-type reinforcements, which are woven: in the reinforcement 11a, the fabric is disposed in such a way that its weft threads, or even its warp threads, are at least approximately oriented in the longitudinal direction of the joining device 1, while in the reinforcement 11b the fabric is disposed so that its weft threads and its warp threads are oblique relative to the longitudinal direction of the joining device 1.

By way of a reminder, by convention the longitudinal direction X of the joining device 1 corresponds, in the present description, to the longitudinal direction X of the conveyor belt 2, with the joining device 1 being mounted on the ends 3 of the conveyor belt 2 that it connects. The transverse direction Y of the joining device 1 is, according to the same convention, the direction perpendicular to the longitudinal direction X. This convention is applied irrespective of the effective dimensions of the joining device 1 in these two directions.

The joining device of FIG. 1 is made up of three elements: an element forming an upper joining plate 4, an intermediate element 9 located under the middle part of the joining plate 4, which is not visible in FIG. 1 other than by the two dashed lines located on either side of the two middle screws 5 delimiting, under the upper joining plate 4, the edges of the ends of the conveyor belt 2 to be connected, and an element forming a lower joining plate 4, not shown in FIG. 1, which is located under the intermediate element 9 and under the element forming the upper joining plate 4.

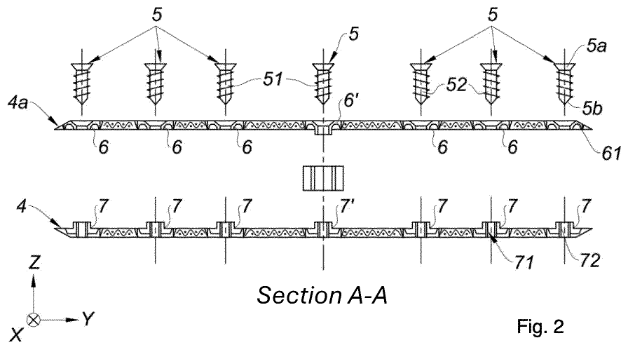

The exploded section of FIG. 2 successively shows assembly screws 51 forming fastening means 5, the upper joining plate 4a, inserts 6 incorporated in the upper joining plate 4, the intermediate element 9 comprising an incorporated through-bushing, vertically disposed along a vertical axis Z, with the lower plate 3 comprising tapped inserts 7.

The inserts 6 arranged to accommodate the heads 5a of screws 51 are generally in the form of perforated washers 61 comprising a cup able to house the heads 5a of the screws 5 intended to pass into the hole of the perforated washers. The central insert 6′ is generally in the form of the inserts 6 but it comprises a central tubular portion, the inner cylindrical surface of which is able to allow through the corresponding screw 5, with very little clearance, with this screw therefore not being screwed into the insert 6′. The central tubular portion of the insert 6′ protrudes from the lower surface of the upper joining plate 4.

The inserts 7 each comprise a central tubular portion, the inner cylindrical surface of which is tapped and is able to accommodate a screw 51 screwed into the tapping, with said central tubular portions protruding from the upper surface of the lower joining plate 4 of the joining device 1. The middle inserts 7′ of the lower plate are in the form of the inserts 7.

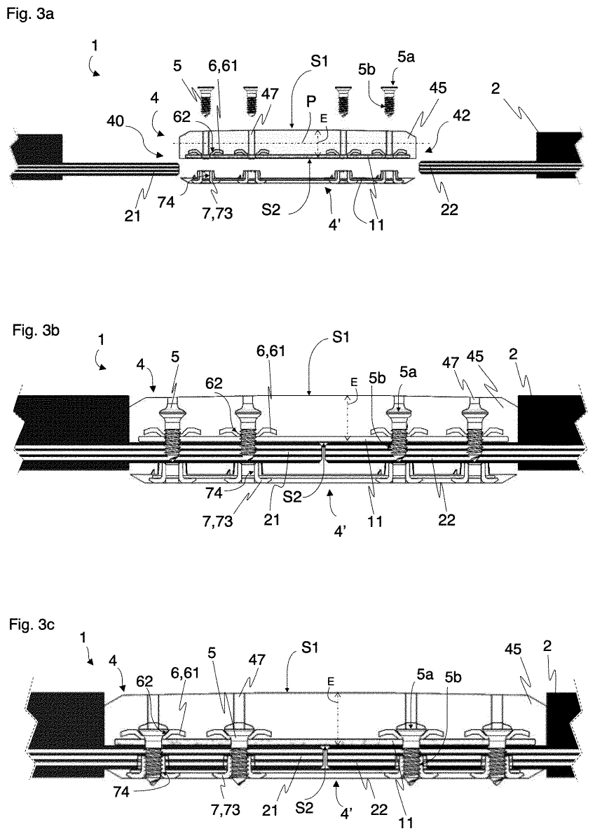

FIGS. 3a, 3b and 3c illustrate a joining device 1 according to a first embodiment of the invention. The joining device 1 comprises a first joining plate 4. In this embodiment, the joining device 1 also comprises a second joining plate 4′. These first and second joining plates 4, 49 each have a body 45 made of a flexible and resilient material, for example made of vulcanized rubber, or of a synthetic material such as polyurethane, and they comprise a reinforcement plate 11 rigidly connected to the body 45 of the associated joining plate 4, 4′. The reinforcement plate 11 is made up of one or more textile layers, so as to form a woven reinforcement. This material forms the body of each of these two joining plates 4, 4′. The reinforcement plate 11 comprises fastening through-holes each surrounding at least the fastening means 5 in the joining position, or even also a given insert.

The joining plates 4, 4′ are configured to each cover a separate side of end portions 21, 22 of a conveyor belt 2, so that the conveyor belt 2 is vertically interposed between the first and second joining plates 4, 4′. The first and second joining plates 4, 4′ together form a first pair of wings 40, which clamp the first end portion 21 of the conveyor belt 2, and a second pair of wings 42, which clamp the second end portion 22 of the conveyor belt 2 in a joining position. The two joining plates 4, 4′ are fastened together with the end portions 21, 22 of the conveyor belt 2 by fastening means 5 arranged to at least partly penetrate the first upper joining plate 4, the end portions 21, 22 and then the second lower joining plate 4′, respectively.

The first joining plate 4 comprises a body 45 made of a flexible and resilient material such as rubber. The first joining plate 4 has an outer surface S1 intended to be flush, i.e., level, with a useful surface of the conveyor belt 2 in the joining position. The outer surface S1 in this case is formed by an outer surface of the body. The useful surface of the conveyor belt 2 corresponds to the surface of the conveyor belt 2 on which the various conveyed materials or products rest. The first joining plate 4 also has an inner surface S2, opposite the outer surface S1 and in this case is formed by an inner surface of the body and of the reinforcement plate 11. The inner surface S2 is intended to cover a separate side of the two end portions 21, 22 of the conveyor belt 2 in the joining position, so as to straddle over these two end portions 21, 22. The inner and outer surfaces S1, S2 delimit a thickness E of the associated joining plate 4.

The thickness E of the first joining plate 4 is greater than a thickness of the second joining plate 4′, preferably greater than or equal to twice the thickness of the second joining plate 4′, more preferably greater than or equal to three times the thickness of the second joining plate 4′. Such a joining plate 4 is referred to as a “high-endurance coating” plate. The reinforcement plate 11 of the joining plate 4 is housed inside the body 45 of the joining plate and extends parallel to the outer surface S1. In this case, the thickness of the second lower joining plate 4′ is defined, and therefore measured, in a manner similar to that of the first upper joining plate 4, between its outer and inner surfaces in a zone without an insert, with the outer surface this time being flush with an inner surface of the conveyor belt 2 in the joining position intended to come into contact with the return and drive components of said conveyor belt 2 opposite the useful surface of said conveyor belt 2.

The first joining plate 4 forming the upper joining plate of the joining device further comprises a plurality of inserts 6 for at least partly accommodating the fastening means 5 of the joining device 1, with at least the end portions 21, 22. These inserts 6 are at least partly embedded in the body 45 and each have a fastening opening associated with one of the fastening holes of the reinforcement plate 11, so as to surround a rim of the associated fastening hole on one side of the reinforcement plate 11, in order to accommodate means 5 of the joining device 1, with at least the end portions 21, 22.

The reinforcement 11 and the inserts 6 are housed in a lower half of the joining plate 4 relative to its thickness E adjoining the inner surface S2, preferably by means of a vulcanization method. The term “lower half” is understood to mean a portion of the joining plate 4 that extends from the inner surface S2 to a middle limit equidistant from the inner and outer surfaces S1, S2, with this middle limit forming a joining plane P of the joining plate 4. The lower half is opposite the “upper half” of the joining plate 4 relative to this middle plane P, which upper half overlays the lower half. The upper half of the joining plate 4 is thus formed by the single constituent material of its body 45 and is strictly devoid of inserts or fastening elements 5, which gives the first joining plate 4 increased flexibility and better dynamic behavior, in particular in contact with drive and return components. This upper part is also the part that experiences the most resilient deformation when a portion of the conveyor belt passes over a return component, offering both significant extensibility in the longitudinal direction of the conveyor belt and suitable wear resistance, since a thickness of the material of the body 45 located above the reinforcement plate 11 and the inserts 6 is relatively high due to the fact that it is a high-endurance coating plate. In particular, the body 45 has a minimum thickness, measured between the outer surface S1 and the inserts 6, that is greater than or equal to a distance equal to a height of the associated inserts 6. This provides a good compromise between resilience and resistance.

In the embodiment described with reference to FIGS. 3a, 3b and 3c, the body 45 comprises through-holes 47 extending in line with each of the inserts 6, from the inner surface S1 of the body where they emerge toward the inner surface S2 of the body 45. These through-holes 47 of the joining plate 4 have a cylindrical shape and are erected generally vertically. The through-holes 47 are configured to be traversed by the fastening means 5 of the joining plate 4 lengthwise. The extensibility of the body 45 ranges between 15% and 40%, preferably between 20% and 30%, so that the through-holes 47 resiliently deform when they are traversed by the fastening elements 5. In this case, each through-hole 47 is oriented so as to be coaxial with an opening for fastening an associated insert 6 of the first joining plate 4 and an associated fastening hole of the reinforcement plate 11. Each through-hole 47 continuously extends as far as the fastening opening of the associated insert 6, itself surrounding an associated fastening hole of the reinforcement plate 11. In such a configuration, the through-holes 47 delimited by the body 45 each provide a lane function for routing the fastening means 5 to the associated insert 6 of the joining plate 4 with which it can cooperate.

Like the first joining plate 4, the associated second joining plate 4′ comprises a plurality of inserts 7, preferably vulcanized.

The fastening means 5 of the joining device 1 each comprise a head 5a configured to cooperate with a portion of the inserts 6, 7 and an anchoring section 5b in order to cooperate with the other portion of the inserts 6, 7.

In general, each joining plate 4, 4′ of the joining device 1 comprises first interfaces for cooperating with the heads 5a of the fastening means 5 and second interfaces for cooperating with the anchoring sections 5b of the fastening means 5, with the second interfaces being separate from the first interfaces and comprising inserts at least partly incorporated into the associated joining plate 4, 4′, In the described embodiment, the anchoring section 5b is provided with a thread.

Each fastening means 5 thus locally fastens one of the joining plates from among the first and the second joining plate 4, 4′ with the other joining plate from among the first and the second joining plate 4, 4′, while passing through one of the end portions 21, 22 of the conveyor belt 2 interposed between the first and second joining plates 4, 4′ in the joining position. By virtue of a pair of a first type of inserts from among the inserts 6, 7 and of a second type of associated inserts from among the inserts 6, 7 of a given fastening means 5, the fastening can remain locked.

In this embodiment, the inserts 6 of the first joining plate 4 form a first part of the inserts of the first interface. They comprise a perforated washer 61 comprising a cup 62 able to house the head 5a of the fastening means 5. When joining the first and second end portions of the conveyor belt 2 together, each screw 5 is inserted through one of the corresponding holes 47 of the first joining plate 4 until its head 5a is housed in the cup 62 of the washer 61 forming the insert 6. This type of insert is fully embedded in the body 45 of the joining plate.

The inserts 7 of the second joining plate 4′ form a second part of the inserts of the second interface. They comprise a cylindrical tubular portion 73, an inner cylindrical surface 74 of which is able to cooperate with the anchoring section 5b of the fastening means 5. In the described embodiment, the inner cylindrical surface 74 comprises a tapping. When joining the first and second end portions of the conveyor belt 2 together, each screw 5 is inserted through one of the corresponding holes 47 of the first joining plate 4 until its head 5a is housed in the cup 62 of the washer 61 forming the insert 6 and, concomitantly, until the threaded anchoring section 5b passes through the corresponding end portion of the conveyor belt 2 and then screws into the tapping 74 of the insert 7. This type of insert is partly embedded in the body 45 of the joining plate, with at least a portion of the cylindrical tubular portion 73 projecting from the inner surface of the associated joining plate.

In the joining device 1, the through-holes 47 of the joining plate 4 are each coaxial with each pair of associated inserts 6, 7 of the first joining plate 4 and of the second joining plate 4′. In the described embodiment, a diameter of the through-holes 47 is strictly less than an outer diameter of the head Sa of the associated fastening element and in this case is strictly less than a diameter of a fastening opening of the associated insert 6, so that the body 45 partly covers the fastening openings of the inserts, while ensuring the passage of the rod of the associated fastening element 5. In particular, in this case, the diameter of the through-holes 47 is equal to the thread root diameter of the thread of the anchoring section 5b of the associated fastening element 5. In this way, the screw can be inserted into the insert 6 after passing through the through-hole 47, by being screwed into the material of the body 45 that partly covers the fastening openings of the inserts 6. In other words, this allows the fastening element 5 to be screwed into the body 45 delimiting the associated hole 47. Thus, the through-holes 47 resiliently deform when the fastening element 5 is introduced, then return to their initial diameter, at least on the screw head, and fulfil a function of ensuring the passage of the screw by screwing. This also allows screws to be kept prepositioned in the body of the joining plate 4. The outer surface SI actually has a useful surface area that is greater than that of the prior art, where the screw heads come level with this surface of the conveyor belt. Furthermore, the size of the holes 47 reduces the risk of cracks appearing, which increases the service life of the associated joining plate 4. In practice, it also has been noted that the passage of the screw does not create premature wear of the joining plate.

This embodiment allows the joining device 1 to be mounted on a conveyor from above, with the least amount of cavities and asperities possible in order to thus limit degradation due to abrasion. The coating of the junction can wear in the same way as that of the conveyor belt without affecting the fastening elements and the inserts. With a shorter threaded fastener, better dynamic operation is provided on high-endurance coating belts.

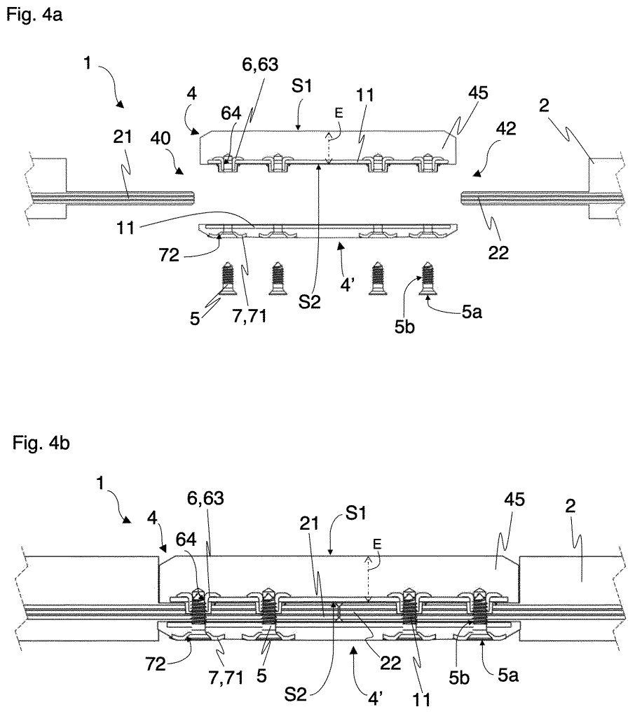

FIGS. 4a and 4b illustrate a joining device 1 according to another described embodiment of the invention that basically differs from the previous embodiment in that the inserts 6 of the first upper joining plate 4 form part of the inserts, in this case of the second interface, and in that the body 45 of the first upper joining plate fully, and not only partly, covers the fastening openings of the inserts 6. They comprise a cylindrical tubular portion 63 delimiting the fastening opening and having an inner cylindrical surface 64 that is able to cooperate with the anchoring section 5b of the fastening means. The inserts 7 of the second lower joining plate 4′ form part of the inserts, in this case of the first interface. They comprise a perforated washer 71 comprising a cup 72 delimiting the fastening opening and able to house the head 5a of the fastening means 5. In the described embodiment, the inner cylindrical surface 74 comprises a tapping.

In this case, the holes 47 are not through-holes and extend from the inner surface S2 of the body 45 into the lower half of the first joining plate 4. In other words, the body 45 that fully covers the fastening openings of the inserts 6. The outer surface S1 is thus devoid of any interface that would represent zones conducive to the appearance of structural defects such as cracks.

This embodiment allows the joining device to be mounted on a conveyor from below, but allows a holeless junction coating to be provided on the face in contact with the materials to be conveyed. This offers an advantage since the coating will be as smooth as the coating of the belt, and therefore less sensitive to abrasion. The coating thickness can vary as a function of the coating thickness of the belt. In this case, the length of the screws is no longer influenced by the thickness of the coating. Shorter screws ensure better dynamic operation.

Naturally, the invention is described above by way of example. It is understood that a person skilled in the art is able to produce various alternative embodiments of the invention, yet without departing from the scope of the invention.

It should be noted that all the features, as they are set forth for a person skilled in the art from the present description, the drawings and the attached claims, even if, strictly speaking, they have only been described in relation to other determined features, both individually and in any combinations, can be combined with other features or groups of features disclosed herein, provided that this has not been expressly excluded or that technical circumstances make such combinations impossible or meaningless.

1. A joining plate for a joining device for a conveyor belt intended to connect two end portions of at least one conveyor belt, the joining plate having an outer surface intended to be flush with a useful surface of the conveyor belt in the joining position and an inner surface opposite the outer surface and intended to at least partially cover the two end portions of the conveyor belt in the joining position, the joining plate comprising:
a body made of flexible material, having an outer surface forming the outer surface of the joining plate;
a reinforcement plate having fastening through-holes, rigidly connected to the body; and
a plurality of inserts at least partly embedded in the body and each having a fastening opening associated with one of the fastening holes, so as to surround a rim of the associated fastening hole on one side of the reinforcement plate, for accommodating fastening means of the joining device with the end portions;
the joining plate being characterized in that the body at least partly covers the fastening openings of the inserts.

2. The joining plate as claimed in claim 2, wherein the body has a minimum thickness, measured between the outer surface and the inserts that is greater than or equal to a distance equal to a height of the associated inserts.

3. The joining plate as claimed in claim 1, wherein the joining plate has an outer surface formed by an outer surface of the body and an inner surface opposite the outer surface and formed by an inner surface of the body and/or of the reinforcement plate, the outer surface and the inner surface being equidistant from each other on either side of a middle plane of the joining plate, the reinforcement and the inserts being positioned on the inner side of the joining plate relative to the middle plane, preferably between the middle plane and the inner surface

4. The joining plate as claimed in claim 1, wherein the reinforcement plate is housed in the body and extends at a constant distance from the outer surface.

5. The joining plate as claimed in claim 1, wherein the body is formed from an elastomer material, preferably made of rubber, and has extensibility ranging between 15% and 40%, preferably between 20% and 30%.

6. The joining plate as claimed in claim 1, wherein the body of the joining plate comprises holes extending from the inner surface of the body in the lower half of the joining plate, the holes being configured to partly house the fastening means.

7. The joining plate as claimed in claim 1, wherein the body comprises through-holes, extending from the outer surface of the body of the joining plate toward the inner surface, the holes being configured to be each traversed by one of the fastening means.

8. The joining plate as claimed in the claim 7, wherein each of the through-holes is coaxial with one of the fastening openings of one of the associated inserts of the joining plate.

9. A joining device for a conveyor belt intended to connect two end portions of at least one conveyor belt comprising:
a joining plate having an outer surface intended to be flush with a useful surface of the conveyor belt in the joining position and an inner surface opposite the outer surface and intended to at least partially cover the two end portions of the conveyor belt in the joining position;
a body made of flexible material, having an outer surface forming the outer surface of the joining plate;
a reinforcement plate having fastening through-holes, rigidly connected to the body; and
a plurality of inserts at least partly embedded in the body and each having a fastening opening associated with one of the fastening holes, so as to surround a rim of the associated fastening hole on one side of the reinforcement plate, for accommodating fastening means of the joining device with the end portions;
wherein the body at least partly covers the fastening openings of the inserts.

10. The joining device for a conveyor belt as claimed in claim 9, further comprising comprises wherein the joining plate comprises a first joining plate as and a second plate comprising a plurality of inserts, the two plates being configured to each cover a separate side of the ends of the conveyor belt so that said conveyor belt is disposed between the two joining plates in the joining position, the first and second joining plates being fastened together by fastening means arranged to at least partly respectively penetrate a joining plate from among the first and the second joining plate, one of the end portions of the conveyor belt and then the other joining plate from among the first and the second joining plate.

11. The joining device as claimed in the claim 10, wherein a thickness of the first joining plate is greater than or equal to, preferably strictly greater than, a thickness of the second joining plate of the joining device preferably greater than or equal to twice the thickness of the second joining plate, more preferably greater than or equal to three times the thickness of the second joining plate.

12. The joining device as claimed in claim 11, wherein the fastening means comprise rod fastening means, preferably of the screw type, the fastening means each preferably comprising a head configured to cooperate with a portion of the inserts and an anchoring section, preferably provided with a thread, configured to cooperate with another portion of the inserts.

13. The joining device as claimed in claim 10, wherein the inserts configured to cooperate with a head of the fastening means each comprise a washer perforated by the associated fastening opening surrounded by a cup able to house the head of the fastening means, and the inserts configured to cooperate with an anchoring section of the fastening means each comprise a cylindrical tubular portion delimiting the associated fastening opening for which an inner cylindrical surface is able to cooperate with the anchoring section of the fastening means, the inner cylindrical surface preferably comprising a tapping.

14. The joining device as claimed in claim 13, wherein the first joining plate only comprises tapped inserts configured to cooperate with the threaded anchoring sections of the fastening means

15. The joining device as claimed in claim 13, wherein the first joining plate only comprises inserts configured to cooperate with the heads of the fastening means.

16. The joining device as claimed in of claim 10,wherein the through-holes are each coaxial with the fastening openings of each associated pair of inserts of the first joining plate and of the second joining plate, in the joining position.

17. The joining device as claimed in of claims 10 wherein a diameter of the through-holes is strictly smaller than a diameter of the fastening opening of the associated insert, preferably strictly less than an outer diameter of the head of the associated fastening element, preferably strictly less than a nominal diameter of the anchoring section of the associated fastening element, more preferably substantially equal to the thread root diameter of the thread of the anchoring section of the associated fastening element.

18. A method for manufacturing a joining plate comprising:
manufacturing a continuous series of a plurality of joining plates in strip form; and
cutting, from said strip thus manufactured, joining plates according to predetermined dimensions, the joining plates each comprising:
a body made of flexible material, having an outer surface forming the outer surface of the joining plate;
a reinforcement plate having fastening through-holes, rigidly connected to the body; and
a plurality of inserts at least partly embedded in the body and each having a fastening opening associated with one of the fastening holes, so as to surround a rim of the associated fastening hole on one side of the reinforcement plate, for accommodating fastening means of the joining device with the end portions;
the joining plate being characterized in that the body at least partly covers the fastening openings of the inserts.

19. (canceled)
